(19) United States
(12) Patent Application Publication
(10) Pub. No.: US 2002/0004935 A1
(43) Pub. Date: Jan. 10, 2002

(54) System for remote automated installation and configuration of digital subscriber line modems

(76) Inventors: Allen Joseph Huotari, Garden Grove, CA (US); James Deloney Price III, Lake Forest, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/755,532

(22) Filed: Jan. 5, 2001

Related U.S. Application Data
(60) Provisional application No. 60/216,145, filed on Jul. 3, 2000.
(60) Provisional application No. 60/249,813, filed on Nov. 17, 2000.

(51) Int. Cl. G06F 9/455

(52) U.S. Cl. 717/11

(57) ABSTRACT

An automated installation and configuration system automatically configures Digital Subscriber Line (DSL) modems and associated user systems without a user having any knowledge of operating or networking systems. The system eliminates the need for a truck roll and makes it possible for a DSL modem to be installed across an ordinary telephone line using a conventional modem. The automated system eliminates the errors that occur during the DSL installation and configuration process, and thus facilitates efficient and cost-effective access to DSL technology. The automated system provides three methods for installing a DSL modem. In the first method, an analog modem connects the subscriber's system to a DSL service provider's server and retrieves a configuration file. The automated system then uses the configuration file to configure the subscriber's DSL modem. In the second method, the configuration file is located on a disk or CD-ROM. The automated system retrieves the configuration file from the disk or CD-ROM, and then uses the configuration file to configure the subscriber's DSL modem. In the third method, the automated system uses the user interface of the subscriber system to prompt the subscriber to enter configuration information. The automated system then uses that entered information to create the configuration file, and then uses the configuration file to configure the subscriber's DSL modem.

### REFERENCE TO RELATED APPLICATION

The present application claims priority benefit under 35 U.S.C. §119(e) from U.S. Provisional Application No. 60/216,145 filed Jul. 3, 2000, entitled “dsl-ON Software Specification, ” U.S. Provisional Application No. 60/249,813 filed Nov. 17, 2000, entitled “SYSTEM FOR REMOTE AUTOMATED INSTALLATION AND CONFIGURATION OF DSL MODEMS, ” U.S. Provisional Application No. unknown filed Nov. 17, 2000, entitled “SYSTEM FOR REMOTE AUTOMATED INSTALLATION AND CONFIGURATION OF DSL MODEMS,” and U.S. Provisional Application No. unknown filed Dec. 22, 2000, entitled “SYSTEM FOR REMOTE AUTOMATED INSTALLATION AND CONFIGURATION OF DIGITAL SUBSCRIBER LINE MODEMS, ” which are herewith incorporated by reference.

### BACKGROUND OF THE INVENTION

1. Field of the Invention

The present invention relates in general to a system for installation and configuration of broadband telecommunication devices (which includes electrical, optical, and wireless media) and in particular to an installation and configuration system for Digital Subscriber Line (DSL) modems.

2. Description of the Related Art

DSL is a technology that transforms conventional telephone lines into high speed conduits for data transmission and Internet services. DSL brings high-bandwidth Internet access to homes and small businesses over ordinary copper telephone lines. There are a wide variety of DSL service speeds and options from hundreds of providers worldwide. Unlike a telephone, DSL is “always on” and connected. This means that no time is spent dialing for service and waiting to be connected.

A DSL line has sufficient bandwidth to carry data and voice signals at the same time, and the data part of the line is continuously connected. If the user chooses, the DSL line can be configured so that a portion of the bandwidth is used to transmit an analog signal so that the user can use a telephone and a computer on the same line at the same time.

DSL installations began in 1998. Since that time, due to the convenience of a high-speed DSL connection, the demand for DSL has increased at a rapid pace. At present, DSL subscribers often have to wait up to two to three months for DSL to be installed in their homes or small businesses. This is generally unacceptable to subscribers who have immediate DSL needs.

Delays in DSL installation are often due to a lengthy and confusing installation process that requires the services of a DSL installation technician. Often, the technician is unable to properly install the DSL modem leading to multiple “truck rolls,” the industry term for visits by installation technicians, before a DSL modem is installed correctly. Of course, an increase in truck rolls increases technician labor costs and the related expenses. DSL providers are absorbing some of these costs now, but won't be able to keep absorbing the costs in the near future. Another component of this problem is that only a limited number of technicians are available in the industry to install DSL. For this reason, it can often take over a month before a truck roll is even commissioned to a residence or a place of business.

Another problem with the current DSL installation process is that providers have a difficult time making minor changes to their clients' DSL services after the modems have been installed and configured. This occurs when the configuration information on the DSL subscriber's system is no longer sufficient to properly connect the DSL modem to the DSL service provider. There are currently three common ways a DSL service provider can make these changes. One way is for the service provider to initiate a truck roll to the subscriber's location. Another way is for the subscriber to call a service provider representative in order to be “walked through” the many steps necessary for reconfiguration. Finally, the service provider and the subscriber can attempt, by email correspondence, to “walk through” the reconfiguration.

The initial configuration and any subsequent reconfigurations are all complicated, if not expensive and time-consuming processes that beg for a true cost effective and time effective remedy. Therefore, there is a need for an efficient, error-free, automated DSL installation and configuration system.

### SUMMARY OF THE INVENTION

The present invention is an automated installation and configuration system that installs and configures a DSL modem without the assistance of a technician. The present invention eliminates the need for a truck roll and therefore enables DSL deployment on a mass scale. The present invention eliminates the errors that occur during the DSL installation and configuration process, and thus, facilitates efficient and cost-effective access to DSL technology.

An aspect of the invention is a telecommunications device installation and configuration system for configuring the operation of a DSL telecommunication device and user system. The telecommunications device installation and configuration system comprises a client computer system, wherein the client computer system includes a DSL telecommunications device, a storage device for receiving and storing a file of configuration data for the DSL telecommunication device, a pre-configured telecommunications device, and a plurality of program files. The telecommunications device installation and configuration system further comprises a server system, wherein the server system includes a telecommunications device that communicates with the pre-configured telecommunication device of the client computer system, a configuration database system containing configuration data used to control the operation of DSL telecommunication devices, an identification database system containing data used to identify the client computer system, and program files that create a configuration file. The telecommunications device installation and configuration system further comprises a data input interface that receives user identification data from a user of the client computer system, a display that displays a data entry screen on the client computer system to prompt the user to input the user identification data. The telecommunications device installation and configuration system further comprises a controller coupled to the data input interface, to the display, and to the pre-configured telecommunications device, wherein the controller operates to send the identification data to the server system via the pre-configured telecommunications device, receive configuration data from the server system to be transferred to the pre-configured telecommunications device, generate a communications device control command by converting the configuration data into a configuration file suitable for use with the second telecommunications device, and use the information in the configuration file to configure the DSL telecommunications device and the client computer system to enable the DSL telecommunications device.

Another aspect of the invention is a computer hardware installation and configuration system for installing and configuring a computer hardware device. The computer hardware installation and configuration system comprises a computer system, wherein the computer system includes a user interface system and a pre-configured telecommunications device. The computer hardware installation and configuration system further comprises an identification data structure. The computer hardware installation and configuration system further comprises a configuration data structure. The computer hardware installation and configuration system further comprises a server system, wherein the server system comprises an identification database system, a configuration data generation system, and a server communications system. The computer hardware installation and configuration system further comprises a computer program operating with the computer system, wherein the computer program operates to retrieve user information using the user interface system, compose the identification data structure, transmit the identification data structure to the server system using the pre-configured telecommunications device, retrieve the configuration data structure from the server system using the pre-configured telecommunications device, and configure the computer hardware device and the computer system to properly operate the computer device. The computer hardware installation and configuration system further comprises a server computer program operating with the server system, wherein the server computer program operates to retrieve the identification data structure from the computer system using the server communications system, generate the configuration data structure using data contained in the identification data structure and the configuration data generation system, and transmit the configuration data structure to the computer system using the server communications system.

Another aspect of the invention is a computer hardware installation and configuration system for installing and configuring a computer hardware device. The computer hardware installation and configuration system comprises a computer system, wherein the computer system comprises a user interface system and a configuration data structure. The computer hardware installation and configuration system further comprises a computer program, wherein the computer program operates to retrieve installation and configuration information using the user interface system, generate the configuration data structure using the installation and configuration information, and configure the computer hardware device and the computer system using the configuration data structure to properly operate the computer device.

Another aspect of this invention is a computer hardware installation and configuration system for installing and configuring a computer hardware device. The computer hardware installation and configuration system comprises a computer system, wherein the computer system comprises a user interface system and a data retrieval device. The computer hardware installation and configuration system further comprises an installation and configuration software package residing on a data storage device. The computer hardware installation and configuration system further comprises a configuration data structure. The computer hardware installation and configuration system further comprises a computer program operating with the computer system, wherein the computer program operates to retrieve user information using the user interface system, retrieve the installation and configuration software package from the data storage device using the data retrieval device, generate the configuration data structure using the user information and the installation and configuration software package, and configure the computer hardware device and the computer system using the configuration data structure to properly operate the computer device.

Another aspect of the invention is a software data structure for installing and configuring a computer hardware device. The software data structure comprises data fields containing information pertinent to the installation and configuration of the computer hardware device.

Another aspect of the invention is a software package for installing and configuring a computer hardware device. The software package comprises one or more software programs for installing and configuring various computer hardware devices wherein the software package selects and utilizes an appropriate software program for installing and configuring a particular computer hardware device.

Another aspect of the invention is a computer hardware device installation and configuration system for installing and configuring the operation of a computer hardware device on a computer system. The computer hardware device installation and configuration system comprises a computer hardware configuration data structure, wherein the configuration data structure comprises a data structure independent of the computer hardware device, and a data content specific for the computer hardware device and the computer system. The computer hardware device installation and configuration system further comprises a computer hardware installation and configuration controller, wherein the computer hardware installation and configuration controller comprises a plurality of computer hardware device specific installation and configuration programs, wherein the computer hardware installation and configuration controller operates to read the computer hardware configuration data structure, select an appropriate computer hardware device specific installation and configuration program for the computer hardware device and the computer system, and utilize the appropriate computer hardware device specific installation and configuration program to install and configure the computer hardware device for proper operation of the computer hardware device on the computer system.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

The present invention is described in more detail below in connection with the attached drawings, which are meant to illustrate and not limit the invention, and in which:

FIG. 1 illustrates a block diagram of an automated installation and configuration system, according to aspects of an embodiment of the invention;

FIG. 2 illustrates a block diagram of a user system, according to aspects of an embodiment of the invention;

FIG. 3 illustrates a block diagram of a service provider system, according to aspects of an embodiment of the invention;

FIG. 4 illustrates a data structure diagram of a user data file, according to aspects of an embodiment of the invention;

FIG. 5 illustrates a data structure diagram of a configuration file, according to aspects of an embodiment of the invention;

FIG. 6 illustrates a process flow diagram of a dial-up installation process, according to aspects of an embodiment of the invention;

FIG. 7 illustrates a process flow diagram of a preset installation process, according to aspects of an embodiment of the invention;

FIG. 8 illustrates a process flow diagram of a manual installation process, according to aspects of an embodiment of the invention;

FIG. 9 illustrates a screenshot of the initial configuration screen, according aspects of an embodiment of the invention;

FIG. 10 illustrates a screenshot of a user authentication screen, according to aspects of an embodiment of the invention;

FIG. 11 illustrates a screenshot of the configuration file selection screen, according to aspects of an embodiment of the invention;

FIG. 12 illustrates a screenshot of the Digital Subscriber Line (DSL) settings entry screen, according to aspects of an embodiment of the invention;

FIG. 13 illustrates a screenshot of the Transmission Control Protocol/Internet Protocol (TCP/IP) entry screen, according to aspects of an embodiment of the invention;

FIG. 14 illustrates a screenshot of the Point-to-Point Protocol (PPP) information entry screen, according to aspects of an embodiment of the invention; and

FIG. 15 illustrates a block diagram of an installation program configuring the DSL Physical Layer and the ATM VPI/VCI and TCP/IP, according to aspects of an embodiment of the invention.

### DETAILED DESCRIPTION OF THE PREFERRED EMBODIMENT

The present invention relates to a system for installation and configuration of broadband telecommunication devices (which includes electrical, optical, and wireless media). The present invention will be described herein with respect to an installation and configuration system for Digital Subscriber Line (DSL) modems.

The term DSL or xDSL is used in this application to refer to all varieties of DSL, such as, but not limited to, Asymmetric Digital Subscriber Line (ADSL) (including G.Lite and Rate Adaptive Digital Subscriber Line (RADSL)), High-bit-rate Digital Subscriber Line (HDSL), Symmetric Digital Subscriber Line (SDSL), Single-pair High-speed Digital Subscriber Line (SHDSL), Very High Data Digital Subscriber Line (VDSL) (including Very-high-rate Asymmetric Digital Subscriber Line (VDSL) and Broadband Digital Subscriber Line (BDSL)), and Integrated Services Digital Network Digital Subscriber Line (IDSL).

One aspect of the present invention is to provide a DSL modem installation and configuration system for a complete configuration of the physical layer, Asynchronous Transfer Mode (ATM) Permanent Virtual Connection (PVC), ATM encapsulation, and Transmission Control Protocol/Internet Protocol (TCP/IP) layer settings, without requiring user input for any of the aforementioned settings. More specifically, in order for a DSL modem to be configured properly, the following items must be properly configured:

Asymmetric Digital Subscriber Line (DSL) Physical Layer Standard

Asynchronous Transfer Mode (ATM) Permanent Virtual Connection (PVC), including:

Virtual Path Identifier (VPI)

Virtual Channel Identifier (VCI)

ATM Encapsulation Protocol

Transmission Control Protocol/Internet Protocol (TCP/IP) information, including:

Internet Protocol (IP) Address

Subnet Mask

Default Gateway

Domain Name Service (DNS) Servers

Hostname

Domain

In the dial-up installation process, a DSL user system, comprising a DSL modem connected to the DSL user system, connects to a DSL service provider through a communication medium, such as, for example, a conventional 56K modem. The DSL service provider creates a configuration file for that DSL user system, and the DSL service provider sends the configuration file to the DSL user through the communication medium. The installation and configuration system then uses the configuration file to modify the DSL user system to install and configure the DSL modem connected to the DSL user system.

The configuration file is modem independent. Therefore, the DSL service provider does not need to know what type of DSL modem is connected to the user system.

To facilitate a complete understanding of the invention, the remainder of the detailed description describes the invention with reference to the figures, wherein like elements are referenced with like numerals throughout.

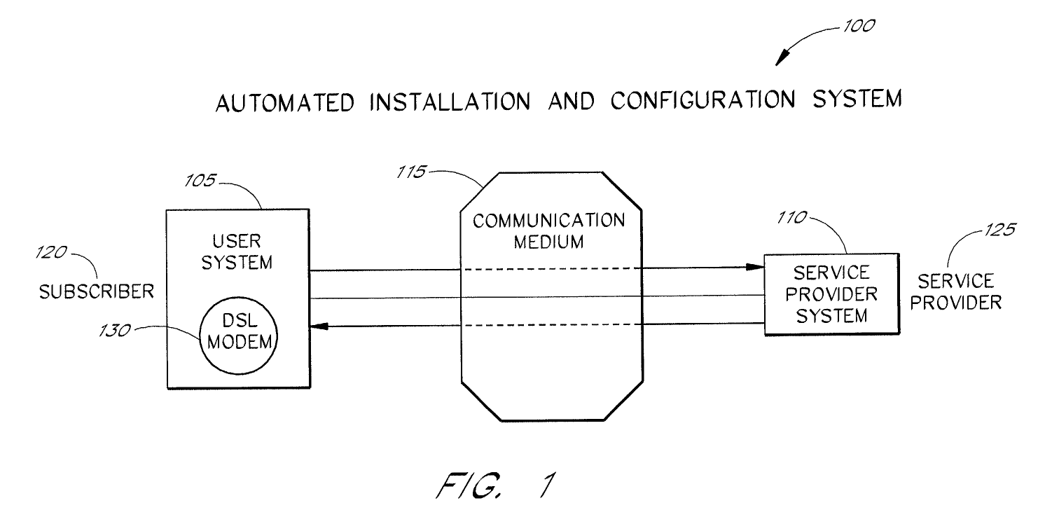

FIG. 1 illustrates a block diagram of an automated installation and configuration system 100 according to aspects of an embodiment of the invention. The automated installation and configuration system includes a user system 105 and a service provider system 110 communicating through a communication medium 115. The user system 105 is operated by a subscriber 120, and the service provider system 110 is operated by a service provider 125.

According to one embodiment of the invention, the user system 105 comprises a conventional general purpose computer using one or more microprocessors such as, for example, an Intel-based processor (e.g., a Pentium III processor or a similar system). Moreover, the user system 105 includes an appropriate operating system such as, for example, an operating system capable of displaying graphics or windows, such as Windows, UNIX, Linux, or the like. As shown in FIG. 1, the user system 105 may include a DSL modem 130. In one embodiment of the invention, the DSL modem 130 comprises any DSL modem such as, for example, a DSL modem by ITeX, Globespan, Infinilink, or the like.

In addition, the user system 105 may connect to the communication medium 115 through a conventional service provider such as, for example, a dial-up connection, digital subscriber line (DSL), cable modem, or the like. According to another embodiment, the user system 105 connects to the communication medium 115 through network connectivity such as, for example, a local or wide area network. According to one embodiment, the operating system includes a TCP/IP stack that handles all incoming and outgoing message traffic passed over the communication link 115.

Although the user system 105 is disclosed with reference to the foregoing embodiments, this invention is not intended to be limited thereby. Rather, a skilled artisan will recognize from the disclosure herein a wide number of alternative embodiments of the user system 105, including almost any computing device capable of sending or receiving information from another computing device. For example, the user system 105 may include a computer workstation, an interactive television, an interactive kiosk, a personal mobile computing device (such as a digital assistant), a mobile phone, a laptop, a wireless communication device, a smart card, an embedded computing device, or any such device which can interact with the communication medium 115. In such alternative systems, the operating systems will likely differ and be adapted for the particular device. However, according to one embodiment, the operating system advantageously continues to provide the appropriate communications protocols needed to establish communication with communication medium 115.

FIG. 1 also illustrates the service provider system 110. According to one embodiment of the invention, the service provider system 110 comprises one or more secure servers for accessing and storing sensitive information such as user authentication data, personal user information, and the user's system information. For example, the authentication data may include a username and password used to gain access to the service provider system 110. The service provider system 110 may also contain information about the user's name, address, system configuration, payment information (such as a credit card), and other personal information. The service provider system 110 is a system which facilitates Internet access by a plurality of user systems 105 such as, for example, Earthlink, American Online, the Microsoft Network, and the like.

FIG. 1 also illustrates the communication medium 115 connecting the user system 105 and the service provider system 110. According to one embodiment, the communication medium 115 comprises the Internet. The Internet, as used throughout this disclosure, is a global network of computers. The structure of the Internet, which is well known to those of ordinary skill in the art, includes a network backbone with networks branching from the backbone. These branches in turn have networks branching from them and so on. Routers move information packets between network levels and then from network to network, until the packet reaches the neighborhood of its destination. From the destination, the destination network host directs the information packet to the appropriate terminal or node. In one advantageous embodiment, the Internet routing hubs comprise domain name system (DNS) servers using Transfer Control Protocol/Internet Protocol (TCP/IP) as is well known in the art. The routing hubs connect to one or more other routing hubs via high speed communication links.

Although the communication medium 115 is disclosed in terms of its preferred embodiment, one of ordinary skill in the art will recognize from the disclosure herein that the communication medium 115 may include a wide range of interactive communication links. For example, the communication medium 115 may include interactive television networks, telephone networks, wireless data transmission systems, two-way cable systems, customized private or public computer networks, interactive kiosk networks, automatic teller machine networks, direct links, satellite or cellular networks, and the like.

FIG. 1 also illustrates the subscriber 120 and the service provider 125. The subscriber 120 is a person or organization operating the user system 105. The service provider 125 is a person or organization operating the service provider system 115 with a view to providing Internet access to a plurality of subscribers 120.

FIG. 2 illustrates a user system 105 according to aspects of an embodiment of the invention. The user system 105 includes a user interface device 205, an operating and networking system 210, one or more data storage and retrieval devices 215, a configured modem 220, the DSL modem 130, and a DSL installation program 135.

In one embodiment of the invention, the user interface device 205 includes any device capable of displaying information to a user and receiving input from the user, such as, for example, a computer monitor and a keyboard, or the like. In one embodiment of the invention, the operating and networking system 210 includes an appropriate operating and networking system to operate the user system 105, such as, for example, Windows NT, UNIX, Linux, Macintosh OS, or the like. In one embodiment of the invention, the user system 105 includes one or more data storage and retrieval devices 215. In one embodiment, the data storage and retrieval device 215 includes a CD ROM, a hard disk drive, a floppy disk drive, or the like.

As illustrated in FIG. 2, the user system 105 includes the configured modem 220. In one embodiment of the invention, the configured modem 220 is any analog modem capable of transmitting and receiving data such as, for example, modems made by Hayes, 3COM, and the like. In one embodiment of the invention, the configured modem 220 is configured to operate without any further installation or configuration. As illustrated in FIG. 2, the configured modem 220 transmits the user data file 300 to the service provider system 110, and the configured modem 220 receives the configuration file 400 from the service provider system 110. The user system 105 includes the DSL modem 130. The DSL modem 130 and the user system 105 is described with reference to FIG. 1.

As illustrated in FIG. 2, the user system 105 includes the DSL installation program 135. The DSL installation program 135 includes all programs required to properly install and configure a DSL modem on the user system 105. The DSL installation program 135 includes an installation control program 225 and an installation wrapper 230. In one embodiment, the installation control program 225 is the program which controls the operation of the DSL installation program 135. The installation wrapper 230 includes one or more modem specific installation programs 235. In one embodiment of the invention, the modem specific installation program 235 is a program designed specifically to install a particular DSL modem. For example, to install the I300 (Globespan USB-based modem), the modem specific installation program 235 comprises a “i300.exe” executable program created by Infinilink (which in turn invokes a “setup.exe” created by Globespan) to install the USB modem. As another example, to install the i200 (ITeX PCI-based) modem, the modem specific installation program 235 comprises a “i200.exe” executable program as created by Infinilink. The modem specific installation programs 225 are discussed in more detail below.

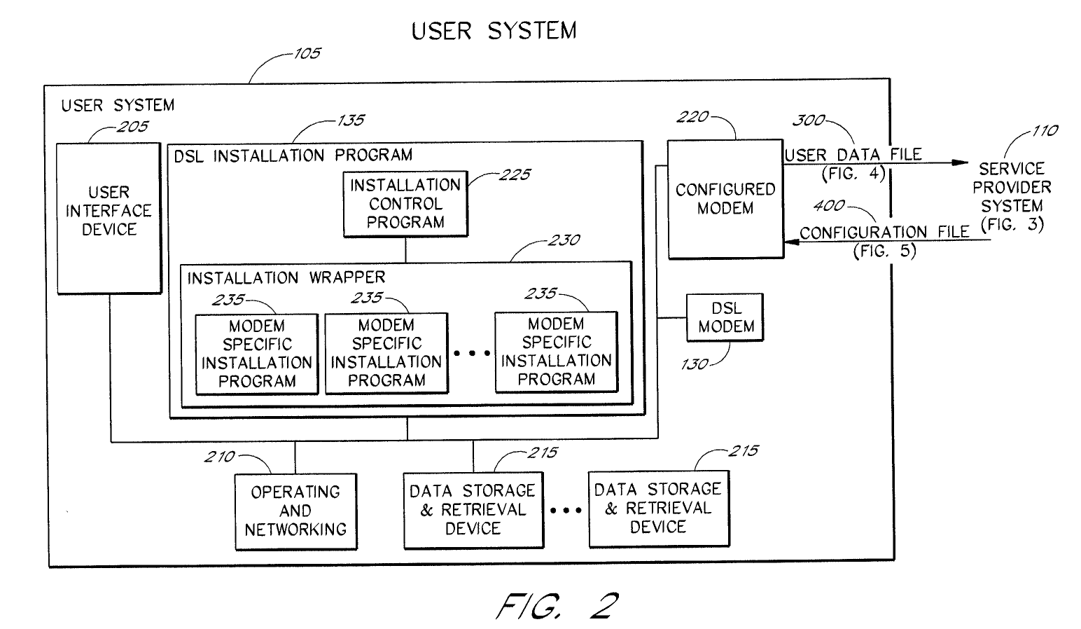

FIG. 3 illustrates a service provider system 110, according to aspects of an embodiment of the invention. The service provider system 110 includes a web server 250 and a DSL user information database 255. In one embodiment, the web server 250 comprises a data routing device such as a conventional web server commercially available from Netscape, Microsoft, Apache, or the like. For example, one function of the web server 250 is to receive incoming data from the communication medium 115. In one embodiment of the invention, the DSL user information database 255 includes any database system capable of storing demographic information about a plurality of individuals such as subscribers 120. For example, the DSL user information database 255 includes username, password, and system information for a plurality of subscribers 120.

As illustrated in FIG. 3, the web server 250 includes a configuration file generation program 260. The configuration file generation program 260 is any program capable of creating and outputting a data file. The configuration file generation program 260 includes programs such as, for example, a program written in Microsoft Visual Basic, C++, Java, or the like.

As illustrated in FIG. 3, the service provider system 125 receives a user data file 300 from the user system 105 through the communication medium 115. The web server 250 then reads the user data file 300 and extracts the login name and the login password field from the user data file 300. Using the login name and login password, the web server 250 queries the DSL user information database 255 to retrieve the system information for the particular corresponding user system 105.

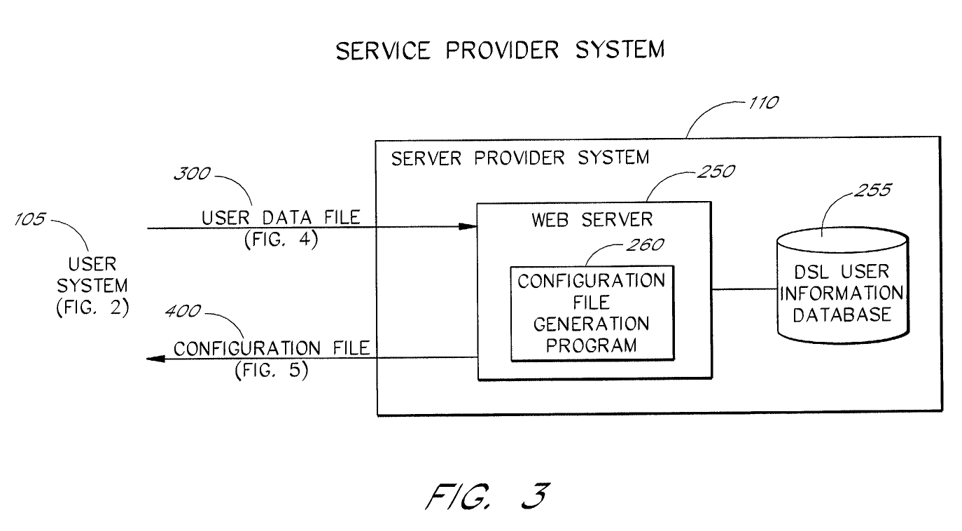

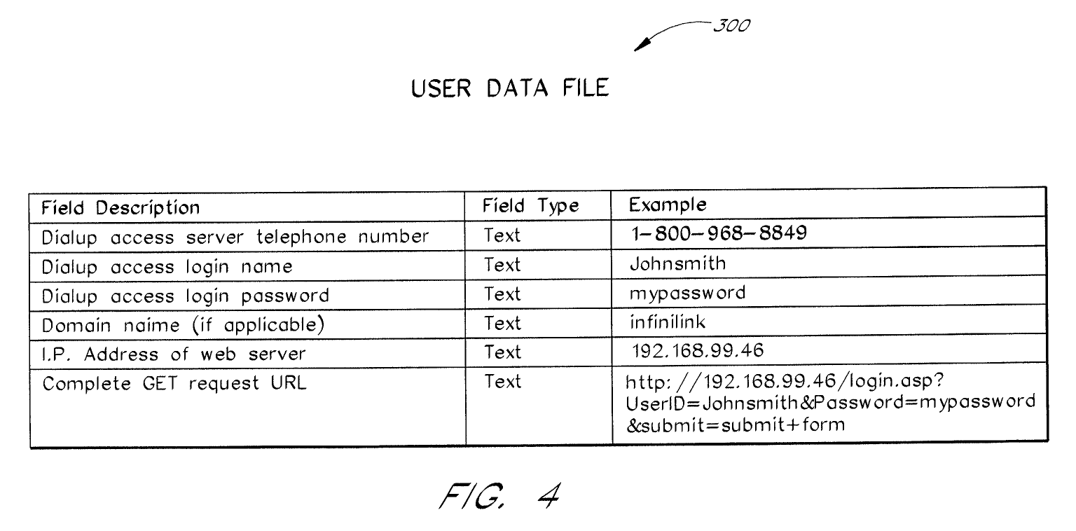

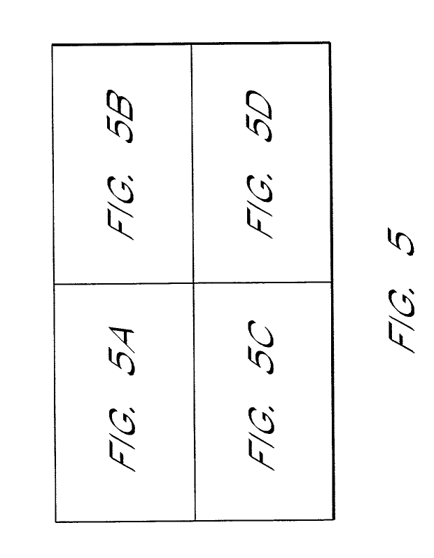

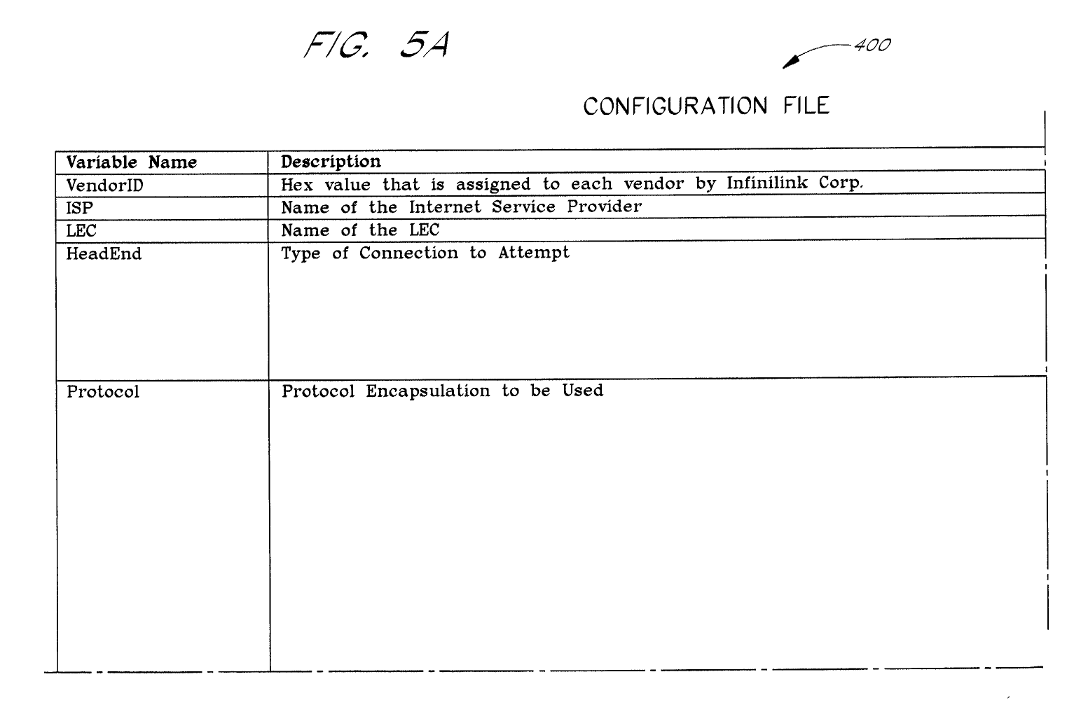

FIG. 4 illustrates a data structure diagram of the user data file 300 according to aspects of an embodiment of the invention. In one embodiment, the user data file 300 includes the following fields: dial-up access server telephone number, dial-up access login name, dial-up access password, domain name, IP address of web server, and complete GET request URL. In one embodiment of the invention, the dial-up access server telephone number is a text field and contains a telephone number of the service provider 125. In one embodiment of the invention, the dial-up access login name is a text field and contains the login name of the subscriber 120. In one embodiment of the invention, the dial-up access login password is a text field and contains the password designated to the subscriber 120. In one embodiment of the invention, the domain name is a text field and contains the domain name of the service provider system 110. In one embodiment of the invention, the Internet Protocol (IP) address of that server is a text field and contains the IP address of the service provider system 110. In one embodiment of the invention, the complete GET request URL is a web request, for example a text string such as:

“http://192.168.99.46/login.asp?UserID=pacbell&Password=fillrate&submit=submit+form”.

Although the user data file 300 is disclosed with reference to the foregoing embodiments, the invention is not intended to be limited thereby. Rather, a skilled artisan will recognize from the disclosure herein a wide number of alternative embodiments of the user data file 300 including almost any data structure capable of containing the information required to identify the user system 105 to the service provider system 110. For example, the user data file 300 in one embodiment may not include a dial-up access login password if, for example, the service provider system 110 does not require a password from the user system 105 to establish a connection. As another example, the user data file 300 in one embodiment may comprise an Extensible Markup Language (XML) file.

The configuration file generation program 260 uses the information retrieved from the DSL user information database 255 and composes a configuration file 400. The configuration file 400 is specific to the user system 105 and contains data necessary to install and configure the DSL modem 130 and the user system 105. The server provider system 125 transmits the configuration file 400 using the communication medium 115 to the user system 105.

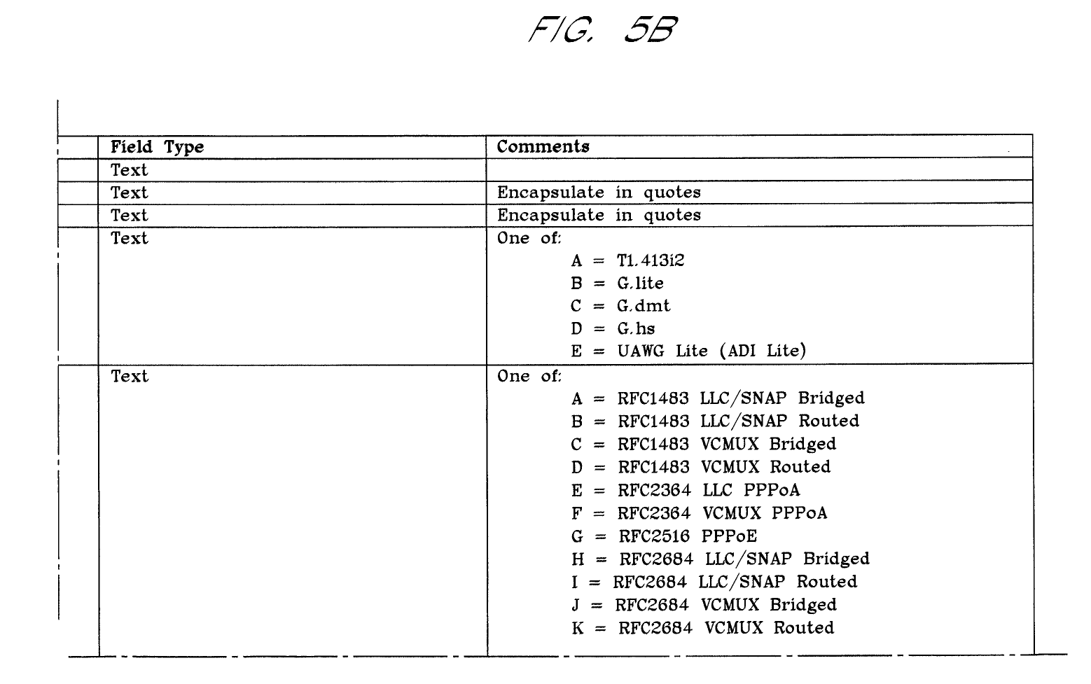

FIG. 5 illustrates a data structure diagram of the configuration file 400 according to aspects of an embodiment of the invention. The configuration file 400 contains a plurality of data fields. FIG. 5 also illustrates a description of the data fields, the data type of the data fields, and comments regarding the data fields. In one embodiment of the invention, the configuration file 400 includes the following fields: Vendor ID, ISP, LEC, HeadEnd, Protocol, PVC count, VPIn, VCIn, Local IP, Subnet Mask, DNS Servers, Host Name, Domain, Gateway, PPP Username, PPP Password, PPPoE Service Name, [ERROR], Bad_Pass, Error_Msg, [END], and Valid. The descriptions, data field types, and comments describing the foregoing fields are also illustrated in FIG. 5. An explanation of the data fields, and their utility in the installation and configuration process is described as follows.

The Vendor ID is a hexadecimal value used to identify an equipment manufacturer or applications developer who is implementing and/or licensing the system described herein. This field is also used in order to allow for optional customization (e.g., interaction of the system with a custom application) for implementers or licensees of the system. This field is assigned to the implementer or licensee of the system.

The ISP is a text value used to identify the Internet service provider. This field is primarily used in order to identify the creator, origin, or source of the configuration file. Since the vendor (an implementer/licensee) of the system described herein could be independent of the organization creating, originating, or providing the configuration file, it is appropriate to have independent identification fields. Note that the Vendor ID and ISP could be identical. This field can be used to aid in authenticating that the configuration file supplied to an end user has originated from a valid source.

The LEC is a text value used to identify the Local Exchange Carrier (LEC). This field is primarily used to identify the network access provider (generally, the LEC is a local telephone company) that provides the broadband service between the ISP and residential or business customer. This field can be used to aid in authenticating that the configuration file supplied to an end user has been created with valid and appropriate network access service provisioning parameters. These network access service provisioning parameters are explained in the following text.

The HeadEnd is a text value used to identify the type of physical layer connection to attempt. Common HeadEnd values are T1.413i2, G.992.1 (or g.dmt), G.992.2 (or g.lite), or UAWG Lite (aka ADI Lite). The HeadEnd type is needed in order to make sure that the physical layer connection type of the customer DSL modem, matches the physical layer connection type provided by the LEC. The HeadEnd type is used to initialize the customer modem for the appropriate physical connection. Examples of HeadEnd types are shown in FIG. 5B. It should be noted that the HeadEnd types shown in FIG. 5B are the most common. HeadEnd types are not limited to those shown in FIG. 5B.

The Protocol is a text value used to identify the protocol encapsulation to be used. Protocol encapsulation is used for inserting IP (Internet Protocol) packets as payload into ATM (Asynchronous Transfer Mode) protocol data units. The Protocol type is used to initialize the customer DSL modem for the appropriate encapsulation method used by the network and/or Internet service providers.

The PVC count is the number of Permanent Virtual Connections (PVCs) for the user system. This value is used to determine the maximum number of PVCs allowed for the user system.

The VPI (Virtual Path Identifier) is a field in the ATM cell header that labels (identifies) a particular virtual path. The VPI is the first of two parameters used to numerically identify a PVC. This field is used to initialize the customer DSL modem for the appropriate PVC provisioned by the LEC.

The VCI (Virtual Channel Identifier) is a field in the ATM cell header that labels (identifies) a particular virtual channel. The VPI is the second of two parameters used to numerically identify a PVC. This field is used to initialize the customer DSL modem for the appropriate PVC provisioned by the LEC.

The Local IP is the user system's currently assigned Internet Protocol (IP) address. This value is required unless assigned by Dynamic Host Configuration Protocol or the Point-to-Point Protocol. The IP address provides a unique identifier of the user system as a network node or client on the Internet. The assignment of the IP address is administrated by the ISP and is assigned statically (a fixed value) or dynamically (assigned on a connection by connection basis from a finite set of values). An IP address must be provided either statically or dynamically in order for the user system to participate on the network.

The Subnet_Mask is the user system's currently assigned subnet mask value. A mask is used to determine what subnet an IP address belongs to. An IP address has two components, the network address and the host address. For example, consider the IP address 200.145.212.070. Assuming this is part of a Class B network, the first two numbers (200.145) represent the Class B network address, and the second two numbers (212.070) identify a particular host on this network. Subnetting enables the network administrator to further divide the host part of the address into two or more subnets. In this case, a part of the host address is reserved to identify the particular subnet. This value is required unless assigned by Dynamic Host Configuration Protocol or the Point-to-Point Protocol.

The DNS Servers is a text data field and contains one or more of the user system's Domain Name System (DNS) servers. A DNS server resolves or translates a text-based domain name to its uniquely assigned IP address. Essentially, a DNS server will accept a request to establish a network connection from a client to a server by taking in the requested text-based domain name (for example, www. example. com) from a client and returning the corresponding IP address (for example, 198.105.232.4) to the client. Without a DNS server, a client would have to know beforehand the IP address of the server that the client wishes to connect to. The DNS Servers field is used in the initialization of the networking properties of the user system. This value is required unless assigned by Dynamic Host Configuration Protocol or the Point-to-Point Protocol.

The Host Name is the name of the user system's host name. The Host Name is the first of two parameters used to identify a networked user account by its host PC name as opposed to the IP address of the host PC. This value is used to initialize the network parameters of the user system. This value is required unless assigned by Dynamic Host Configuration Protocol or the Point-to-Point Protocol.

The Domain is a text data field containing the name of the user system's Internet system provider's domain. The Domain name is the second of two parameters used to identify a networked user account by its host PC name as opposed to the IP address of the host PC. This value is used to initialize the network parameters of the user system. This value is required unless assigned by Dynamic Host Configuration Protocol or the Point-to-Point Protocol.

The Gateway is the IP address of the user system's gateway. The Gateway is the network access default router to which all data packets originating from the user system are directed prior to being forwarded to the Internet. This value is used to initialize the network parameters of the user system. This value is required unless assigned by Dynamic Host Configuration Protocol or the Point-to-Point Protocol.

The PPP Username is the value of the user system's Point-to-Point Protocol username. This value is only required in Point-to-Point Protocol mode. The PPP Username is the first of two parameters used to authorize and authenticate access of the service provider network by the user system.

The PPP Password is the value of the user system's Point-to-Point Protocol password. This value is only required in Point-to-Point Protocol mode. The PPP Password is the second of two parameters used to authorize and authenticate access of the service provider network by the user system.

The PPPoE is the service name for the Point-to-Point Protocol over Ethernet. This field is optional when using Point-to-Point Protocol over Ethernet. This field is used to indicate an ISP name or a class of service (CoS) or a quality of service (QoS).

The [ERROR] field contains the error message, if any, to be reported to the user system. This text field is only used to report error messages to the user. The contents of this field are implementation dependent and may be customized for a licensee of this invention.

The Bad_Pass is a text data field which is set if the user is using an incorrect username and password combination to access the Internet service provider. This field will only contain a value if an incorrect username and password combination is used. This information is returned in the configuration file if either the dialup access login name or dial up access login password is entered incorrectly by a user prior to requesting the configuration file. Therefore, it is used to authorize and authenticate an end user.

The Error_Msg text data field contains the default error message and is merely an indicator that an error has occurred.

The [END] text indicates the end of the configuration file. The “[END]” string in the configuration file does not represent a value, but its presence indicates that the configuration file is complete (i.e., there is no relevant information for installation or configuration after the END).

The Valid text data field is the last line of the configuration file. The Valid field is equal to the number 1. This field is used to indicate that the contents of the entire configuration file are valid (i.e., correct and complete).

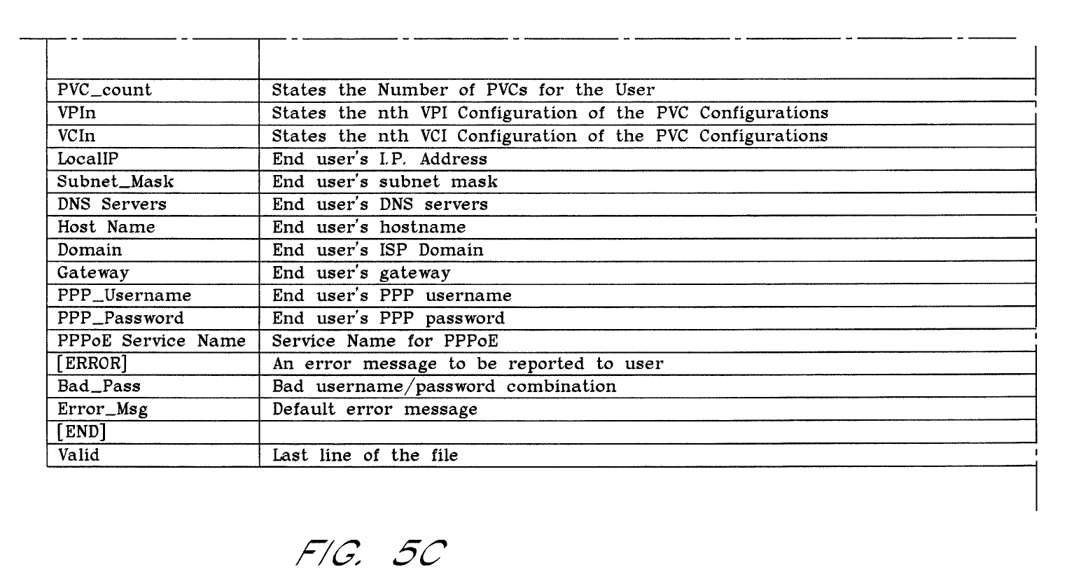

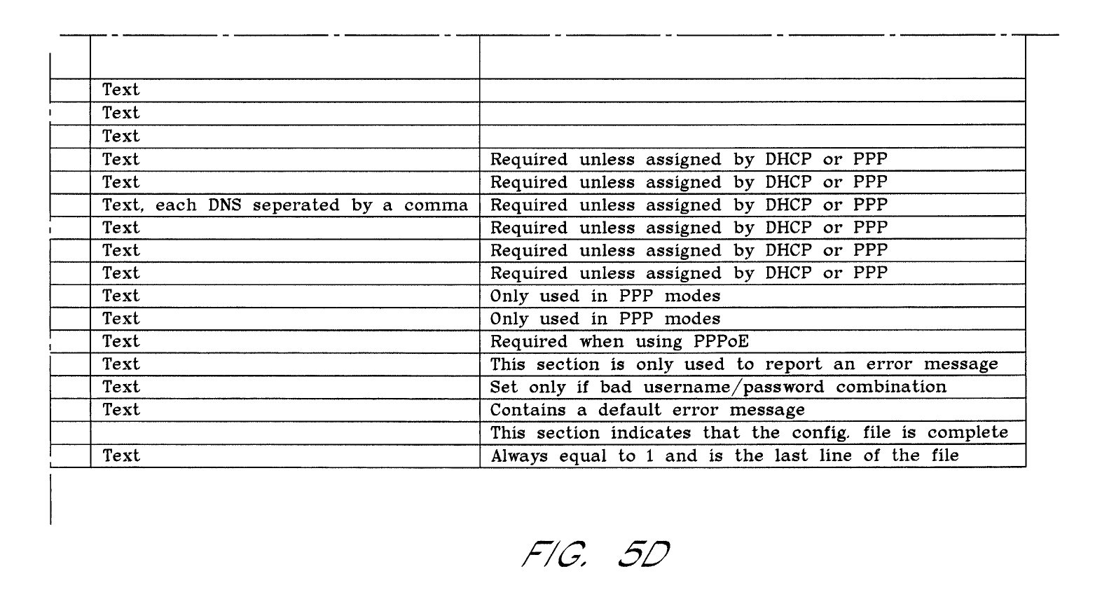

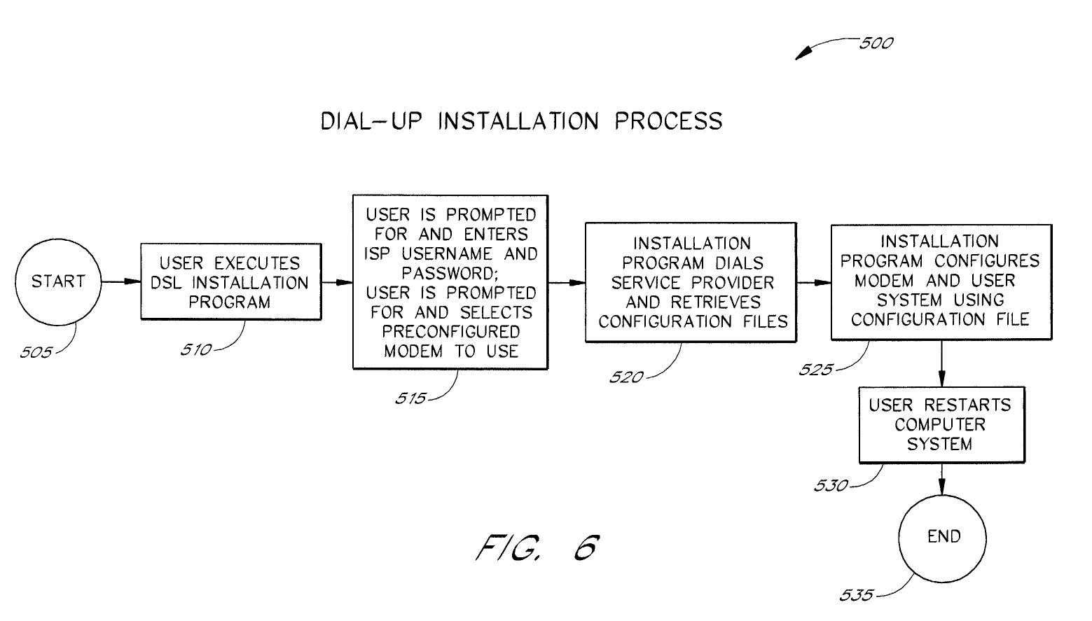

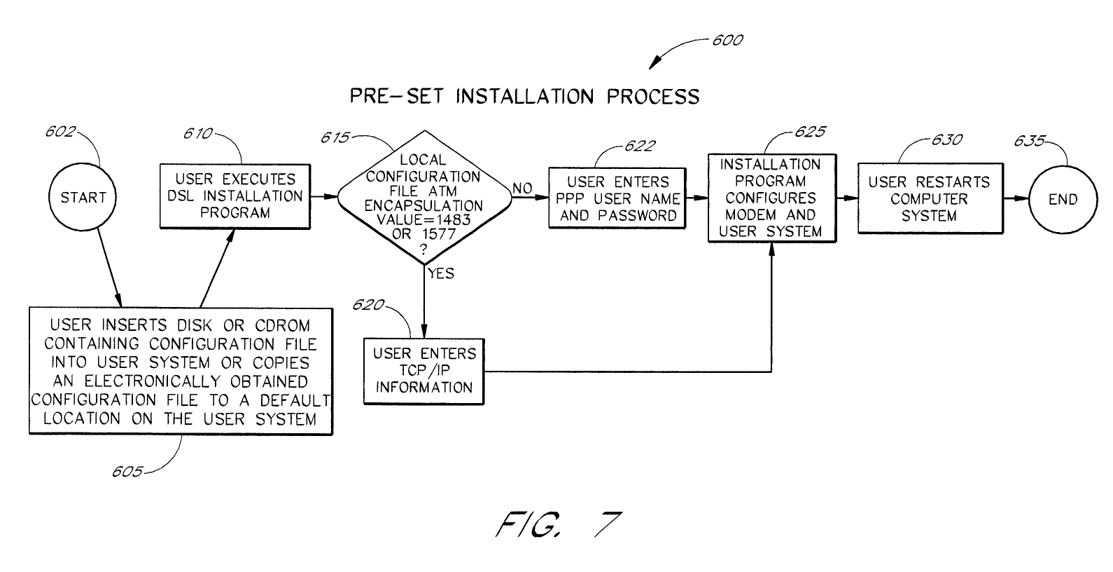

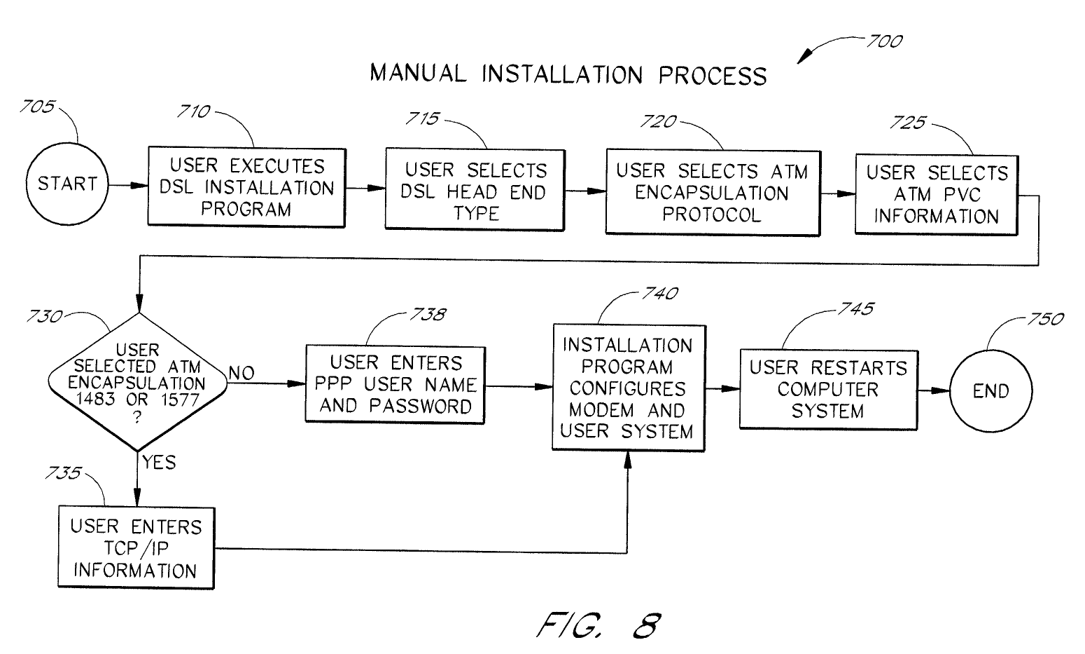

There are at least three ways that the automated installation and configuration system 100 can be executed. One way is by a dial-up installation process as illustrated in FIG. 6. A second way is by a preset installation process as illustrated in FIG. 7. A third way is by a manual installation process as illustrated in FIG. 8.

In the dial-up installation process illustrated in FIG. 6, the DSL installation program 135, through the user interface device 205, prompts the subscriber to enter the subscriber's dial-up access login name and the subscriber's dial-up access login password. The DSL installation program 135 advantageously contains the dial-up access server telephone number, the domain name, the IP address of the web server, and the complete GET request URL. Using the foregoing data and the dial-up access login name and dial-up access login password entered by the subscriber 120, the DSL installation program 135 composes the user data file 300. The DSL installation program 135 then connects to the service provider system 110 with the configured modem 220. Once connected to the service provider system 110, the DSL installation program sends the user data file 300 to the service provider system 110. The service provider system 110, as illustrated in FIG. 3, receives the user data file 300 and returns the configuration file 400 to the user system 105. The DSL installation program 135 retrieves the configuration file 400 using the configured modem 220.

The DSL installation program 135 uses the information in the configuration file 400 to configure the DSL modem 130 and the user system 105. The installation wrapper 230 selects the appropriate modem specific installation program 235 among the one or more modem specific installation programs 235 residing in the installation wrapper 230. The installation wrapper 230 selects the appropriate modem specific installation program 235 that corresponds to the particular DSL modem 130.

In one embodiment of the invention, the modem specific installation program 235 uses the data contained in the configuration file 400 to configure the DSL modem 130 and the user system 105. A DSL modem system used at the subscriber's location is herein referred to as Client Premises Equipment (CPE), and the subscriber's computer system using the CPE is herein referred to as the host computer. Currently there are at least three common types of CPE: controller-based CPE, controller-less CPE, and soft CPE. In a controller-based CPE, both the DSL and the ATM configuration are implemented in the hardware system. Examples of controller-based CPE include: Infinilink i500 (Ethernet), Virata Lithium, Beryllium, and Boron DSL modem systems. In a controller-less CPE, the DSL configuration is implemented in the hardware system and the ATM configuration is implemented in the software system. Examples of controller-less CPE include Infinilink i300 (Universal Serial Bus (USB) based) and Infinilink i200 (Peripheral Component Interconnect (PCI) based) DSL modem systems. In a soft CPE, both the DSL configuration and the ATM configuration are implemented in the software system. Examples of soft CPE include ITeX SAM and PCTEL DSL modem systems.

Each type of CPE has further installation and configuration requirements. For example, within the controller-based CPE type, different data encapsulations may be used. Data encapsulation is a method used for encapsulating network protocols above Asynchronous Transfer Mode into Asynchronous Transfer Mode. Examples of the data encapsulations include: RFC 1483 Bridged, RFC 1483 Routed, RFC 2364 (PPPoA), and RFC 2516 (PPPoE).

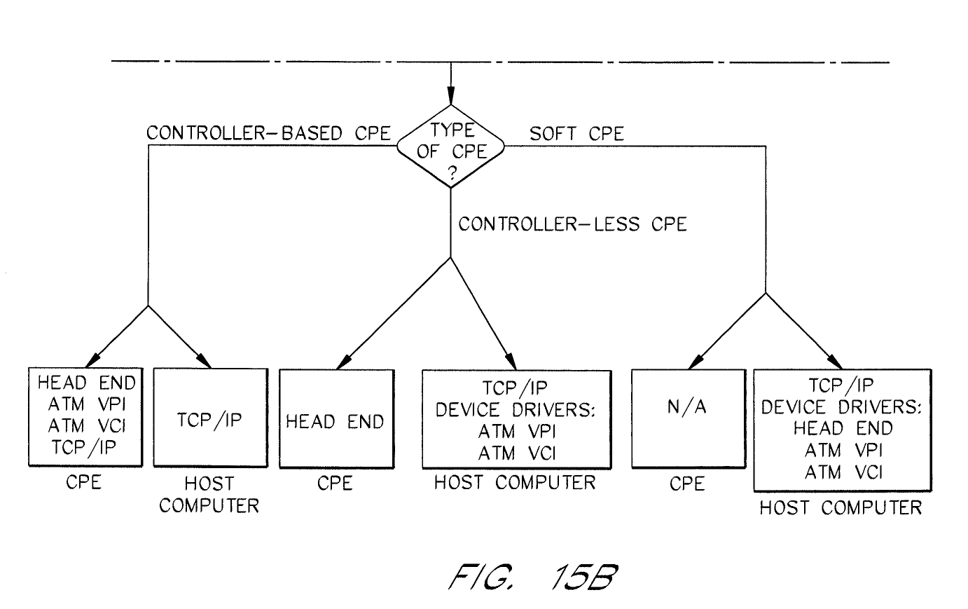

FIG. 15 illustrates a block diagram of the modem specific installation program 235 configuring the DSL Physical Layer, the ATM VPI/VCI parameters, and the TCP/IP parameters on the user system 105 and the DSL modem 130. The function of the DSL Physical Layer is to identify the method used for establishing physical communications between the CPE and the Digital Subscriber Line Access Multiplexer (DSLAM). The function of the ATM VPI/VCI is to identify the ATM Virtual Circuit implemented. TCP/IP is a network protocol used by many network systems. The illustration is meant to demonstrate, as an example, the manner in which the modem specific installation program 235 configures the DSL Physical Layer, the ATM VPI/VCI settings, and the TCP/IP settings, which are only portions of the configuration process. Appendix A illustrates the complete list of the configuration parameters, and the configuration parameters' function, purpose, and configuration location.

As illustrated in FIG. 15, to configure the DSL Physical Layer, the ATM VPI/VCI, and the TCP/IP, the modem specific installation program 235 retrieves the data parameters, including Head End, ATM VPI, ATM VCI, and TCP/IP data parameters, from the configuration file 400. The TCP/IP data parameters include the configuration file 400 data fields containing the IP address, subnet mask, default gateway, DNS servers, host name, and domain name. The modem specific installation program 235 stores the data in the CPE or the host computer according to the type of CPE as discussed in more detail below. Further, CPE products within the same CPE type may have different installation and configuration requirements. Thus, the invention relieves the subscriber from necessarily being aware of the type of CPE the subscriber is using or the installation and configuration requirements of the particular CPE product. Further, the subscriber need not know the appropriate values for the Head End, ATM VPI, ATM VCI, and TCP/IP data parameters.

As illustrated in FIG. 15, in a controller-based CPE, the modem specific installation program 235 stores the Head End, ATM VPI, ATM VCI, and TCP/IP data in the CPE and stores the TCP/IP data in the host computer. In a controller-less CPE, the modem specific installation program 235 stores the Head End data in the CPE and stores the Physical Layer's configuration and settings data and the TCP/IP data in the host computer. In a controller-less CPE, the modem specific installation program 235 stores the ATM VPI and ATM VCI data within the device driver settings of the host computer. In a soft CPE, the modem specific installation program 235 stores the Head End data and the TCP/IP data in the host computer and stores the ATM VPI and ATM VCI data within the device driver settings of the host computer.

As another example, as part of the configuration process, the modem specific installation program 235 sets the data encapsulation configuration of the user system 105 and the DSL modem 130. For example, in a controller-based CPE, one of many possible data encapsulation methods may be used. For example, the foregoing data encapsulation methods may include: RFC 1483 Bridged, RFC 1483 Routed, RFC 2364 (PPPoA), and RFC 2516 (PPPoE), among others. In a RFC 1483 Bridged configuration, the modem specific installation program 235 stores the encapsulation protocol in the CPE and stores the IP Address, Subnet Mask, Default Gateway and DNS Servers data parameters in the host computer. In a RFC 1483 Routed configuration, the modem specific installation program 235 stores the encapsulation protocol, IP Address, Subnet Mask, and Default Gateway data parameters in the CPE and stores the IP Address, Subnet Mask, Default Gateway and DNS Servers data parameters in the host computer. In a RFC 2364 (PPPoA) configuration, the modem specific installation program 235 stores the encapsulation protocol, IP Address, Subnet Mask, and Default Gateway data parameters in the CPE and stores the IP Address, Subnet Mask, Default Gateway, and DNS Servers data parameters in the host computer. In a RFC 2516 (PPPoE) configuration, the modem specific installation program 235 stores the encapsulation protocol in the CPE. Thus, as illustrated in the foregoing examples, the configuration process relieves the subscriber from necessarily being aware of the type of CPE the subscriber is using or the installation and configuration requirements of the particular CPE product. Further, the subscriber need not know the appropriate values for the encapsulation protocol and the related data parameters.

Although the configuration process is disclosed with reference to the foregoing examples, the configuration process is not intended to be limited thereby. Rather, a skilled artisan will recognize from the disclosure herein a wide number of alternative configuration processes. Further, a skilled artisan will recognize that the configuration process may vary for each particular CPE and host computer.

One difference between the dial-up installation process 500, the preset installation process 600, and the manual installation process 700 is the manner in which the configuration file 400 is composed and communicated to the user's system. In the dial-up installation process 500, the configuration file 400 is composed on the service provider system 110 and is transmitted back to the user system 105 for configuration of the DSL modem 130 and the user system 105. In the preset installation process 600, the subscriber 120 inserts a data storage device, such as a CD-ROM or a disk, containing the configuration file 400 into the user system 105. The DSL installation program 135 uses the configuration file 400 residing on the data storage device to configure the DSL modem 130 and the user system 105. In the manual installation process 700, the DSL installation program 135, through the use of the user interface device 205, prompts the subscriber 120 to enter information required to compose the configuration file 400. The DSL installation program 135 uses the configuration file 400 to configure the DSL modem 130 and the user system 105.

FIG. 6 illustrates a process flow diagram of a dial-up installation process 500 according to aspects of one embodiment of the invention. The dial-up installation process 500 starts at a step 505. At a step 510, the subscriber 120 executes the DSL installation program 135. After the subscriber 120 executes the DSL installation program 135, the subscriber 120 is prompted, at a step 515, for the user name and password as assigned to the subscriber 120 by the service provider 125. At the step 515, the subscriber 120 enters his or her assigned user name and password. At the step 515, the subscriber 120 is also prompted to select the appropriate configured modem 220. At the step 515, the user also selects the configured modem 220. At a step 520, the DSL installation program 135 uses the configured modem 220 to connect to the service provider 110 and transmits the user data file 300 to the service provider. Subsequent to transmitting the user data file 300 at the step 520, the installation program retrieves the configuration file 400 from the service provider system 110. At a step 525, the DSL installation program 135 configures the DSL modem 130 and the user system 105 using the configuration file 400 received from the service provider system 110 without further input from the subscriber 120. At a step 530, the user is prompted to restart the user system 105 hardware system. Once the user system 105 hardware system is restarted, at a step 535, the dial-up installation process 500 is complete and the DSL modem 130 and the user system 105 is configured for operation.

FIG. 7 illustrates the pre-set installation process 600 according to aspects of one embodiment of the invention. The pre-set installation process 600 begins at the start state at a step 602. At a step 605, the subscriber 120 inserts the disk or CD ROM containing the configuration file 400 in the appropriate data storage and retrieval device 215 on the user system 105. At a step 610, the subscriber 120 executes the DSL installation program 135 on the user system 105. At a step 615, if the local configuration file field ATM encapsulation protocol value is 1483 or 1577, the process proceeds to a step 620, and the subscriber 120 is prompted to enter the appropriate TCP/IP information (which is blank in the configuration file). The TCP/IP information includes the appropriate information related to IP address, subnet mask, default gateway, DNS servers, host name, and domain name required to configure the DSL modem 130 and the user system 105. Once the user enters the foregoing information, the process moves directly to a step 625. If, at the step 615, the local configuration file ATM encapsulation protocol value was not 1483 and was not 1577, the process moves to a step 622. At the step 622, the user is prompted to enter PPP User Name and Password. Once the subscriber 120 enters the appropriate PPP User Name and Password, the process moves to the step 625. At the step 625, the DSL installation program 135 configures the DSL modem 130 and the user system 105 without further input from the user. At a step 630, the subscriber restarts the user system 105 hardware system. The process then moves to a step 635. At the step 635, the installation and configuration of the DSL modem 130 and the user system 105 is complete.

FIG. 8 illustrates the manual installation process 700 according to aspects of an embodiment of the invention. The manual installation process 700 begins at the start state at a step 705. At a step 710, the subscriber 120 executes the DSL installation program 135 on the user system 105. At a step 715, the user is prompted by the DSL installation program 135 to enter the DSL Head-End type. Once the subscriber 120 enters the DSL Head-End type, the process moves to a step 720 where the DSL installation program 135 prompts the user to select the ATM encapsulation protocol. Once the subscriber 120 enters the appropriate ATM encapsulation protocol, the process moves to a step 725 where the subscriber 120 is prompted to enter the appropriate ATM PVC information. Once the subscriber 120 enters the appropriate ATM PVC information, the process moves to a step 730. At the step 730, if the subscriber 120 has selected 1483 or 1577 in the ATM encapsulation protocol information, the process moves to a step 735. At the step 735, the subscriber 120 is prompted by the DSL installation program 135 to enter the TCP/IP information of the user system 105. Once the subscriber 120 enters the appropriate TCP/IP information, the process moves to a step 740. If at the step 730, the subscriber 120 did not enter 1483 and did not enter 1577 in the ATM encapsulation protocol information of the user system 105, the process moves directly to a step 738. At the step 738 the user is prompted to enter PPP User Name and Password. Once the subscriber 120 enters the appropriate PPP User Name and Password, the process moves directly to the step 740. At the step 740, the DSL installation program 135 configures the DSL modem 130 and the user system 105 using the foregoing information entered by the subscriber 120. Once the DSL modem 130 and the user system 105 is configured, at step 745, the subscriber 120 is prompted by the DSL installation program 135 to restart the user system 105 hardware. Once the subscriber 120 restarts the user system 105 hardware system the process moves to a step 750, and the manual installation process 700 is completed.

FIG. 9 illustrates a screenshot of the initial configuration screen 800 according to aspects of one embodiment of the invention. The initial configuration screen 800 prompts the subscriber 120 to select one of three program options. The program options include installing and configuring DSL device, changing DSL modem settings, and uninstall DSL-ON (where DSL-ON is the name of the application implementing the present invention). When the subscriber 120 initially selects one of the three foregoing options, a description of that option is displayed on the initial configuration screen 800 to assist the subscriber 120 in choosing the appropriate option. Upon choosing the desired option, the subscriber 120 may select the next button on the initial configuration screen 800. The subscriber 120 may also select the “cancel” button to terminate the program.

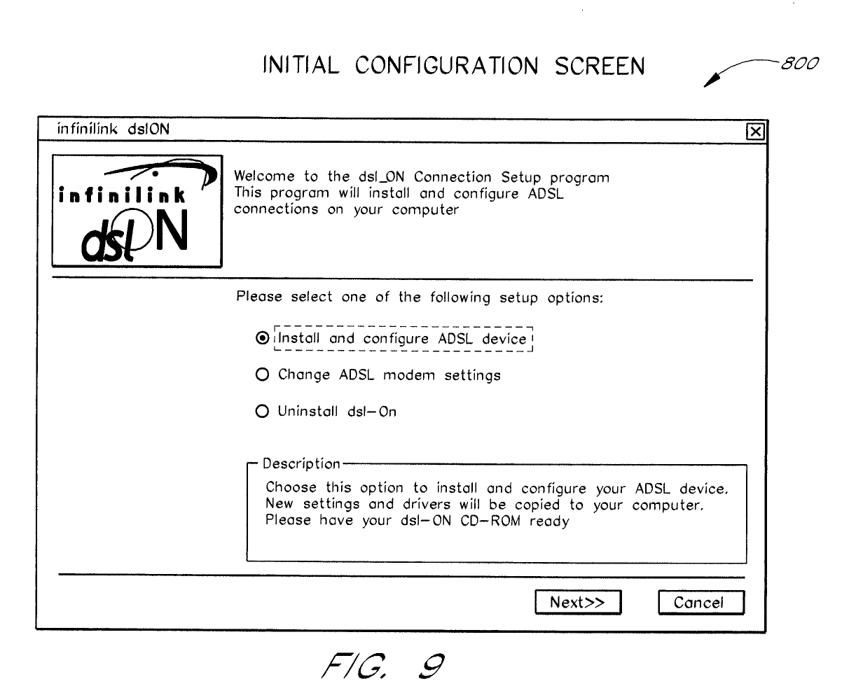

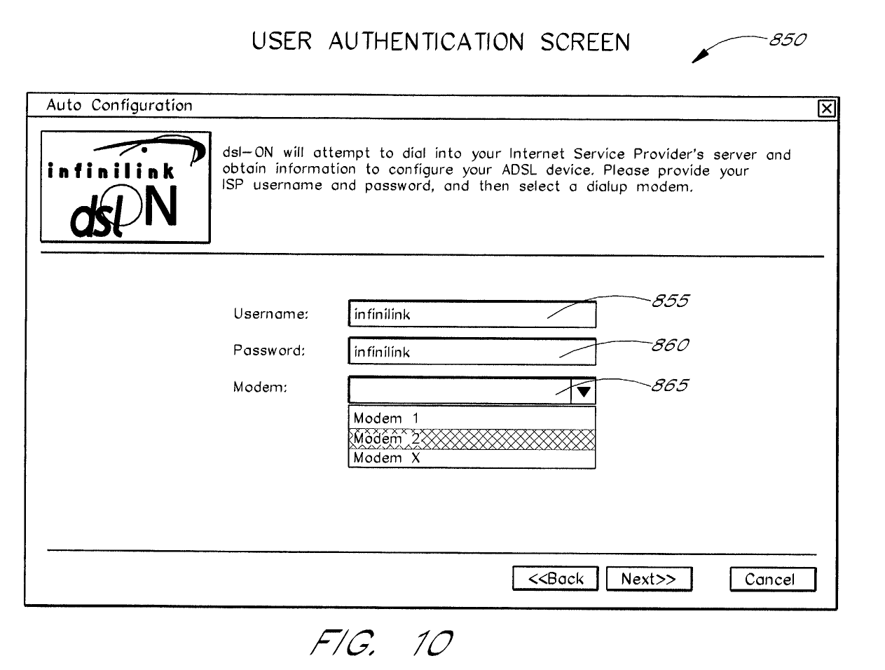

FIG. 10 illustrates a screenshot of the user authentication screen 850 according to aspects of one embodiment of the invention. The user authentication screen 850 includes three data entry sections: a username entry section 855, a password entry section 860, and a modem selection section 865. Once the user authentication screen 850 is displayed, the subscriber 120 may enter the username assigned to the subscriber 120 by the service provider 125 in the username entry section 855. The subscriber 120 may enter the password assigned to the subscriber 120 by the service provider 125 in the password entry section 860. The subscriber 120 may select the configured modem 220 to be used by the DSL installation program 135 in the modem selection section 865. Instructions are visible on the user authentication screen 850 to assist the subscriber 120 in entering appropriate data. Once the appropriate data is entered by the subscriber 120, the subscriber 120 can then select the “next” button to continue with the installation. The subscriber 120 can also select the “back” button to go to the initial configuration screen 800. The subscriber 120 may also select the “cancel” button to terminate the program.

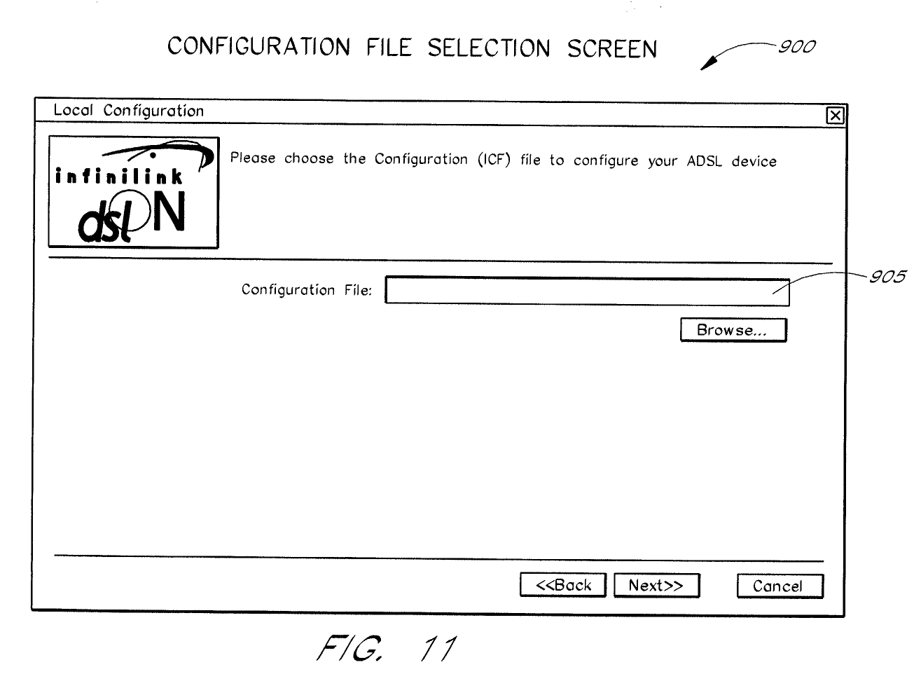

FIG. 11 illustrates a screenshot of the configuration file selection screen 900 according to aspects of one embodiment of the invention. The configuration file selection screen 900 includes a configuration file selection section 905. The subscriber 120 may use the configuration file selection section 905 to select the configuration file 400 to be used by the DSL installation program 135. The subscriber 120 may use the “browse” button to view the user system 105 file directory and select the appropriate configuration file 400. Upon selecting the appropriate configuration file 400, the subscriber 120 may press the “next” button to continue with the installation. The subscriber 120 may instead select the “back” button to go back to the user authentication screen 850. The subscriber 120 may also instead select the “cancel” button to terminate the program.

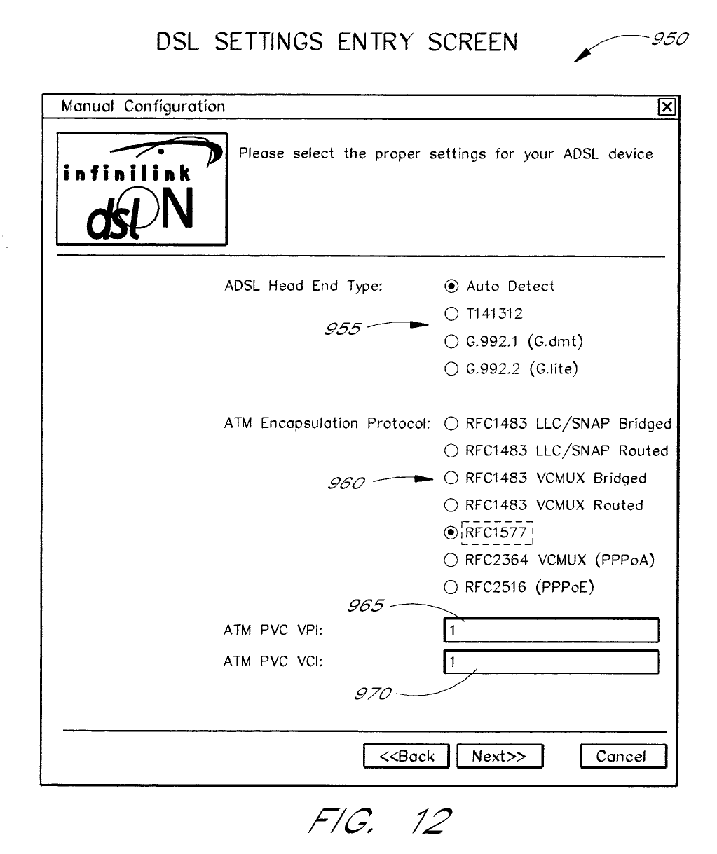

FIG. 12 illustrates a screenshot of the DSL settings entry screen 950 according to aspects of one embodiment of the invention. The DSL settings entry screen 950 includes DSL head end types radio buttons 955, ATM encapsulation protocol radio buttons 960, an ATM PVC VPI data entry section 965, and an ATM PVC VCI data entry section 970. The subscriber 120 may use the DSL head end types radio buttons 955 to select the appropriate setting for the DSL head end type. For example, the subscriber 120 may choose between the following:

Auto Detect

T1 41312

G.992.1 (G.dmt)

G.992.2 (G.lite)

The subscriber 120 may use the ATM encapsulation protocol radio buttons 960 to select the appropriate setting for the ATM encapsulation protocol. For example, the subscriber 120 may choose between the following:

RFC1483 LLC/SNAP Bridged

RFC1483 LLC/SNMP Routed

RFC1483 VCMUX Bridged

RFC1483 VCMUX Routed

RFC1577

RFC2364 VCMUX (PPPoA)

RFC2516 (PPPoE)

The subscriber 120 may use the ATM PVC VPI data entry section 965 to enter the appropriate value for the ATM PVC VPI setting. The subscriber 120 may use the ATM PVC VCI data entry section 965 to enter the appropriate value for the ATM PVC VCI setting. Once the appropriate data is entered by the subscriber 120, the subscriber 120 can then select the “next” button to continue with the installation. The subscriber 120 can instead select the “back” button to go to the configuration file selection screen 900. The subscriber 120 may also select the “cancel” button to terminate the program.

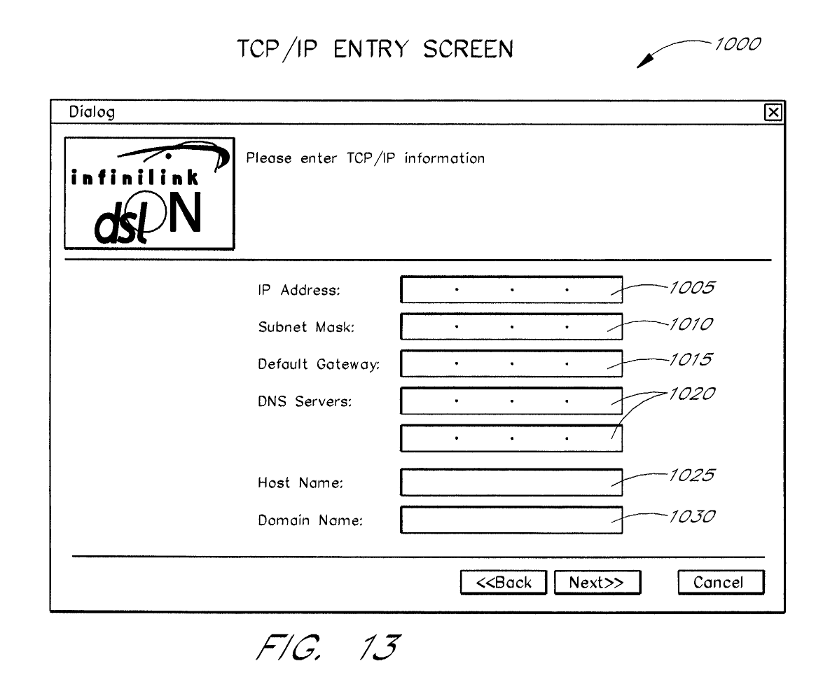

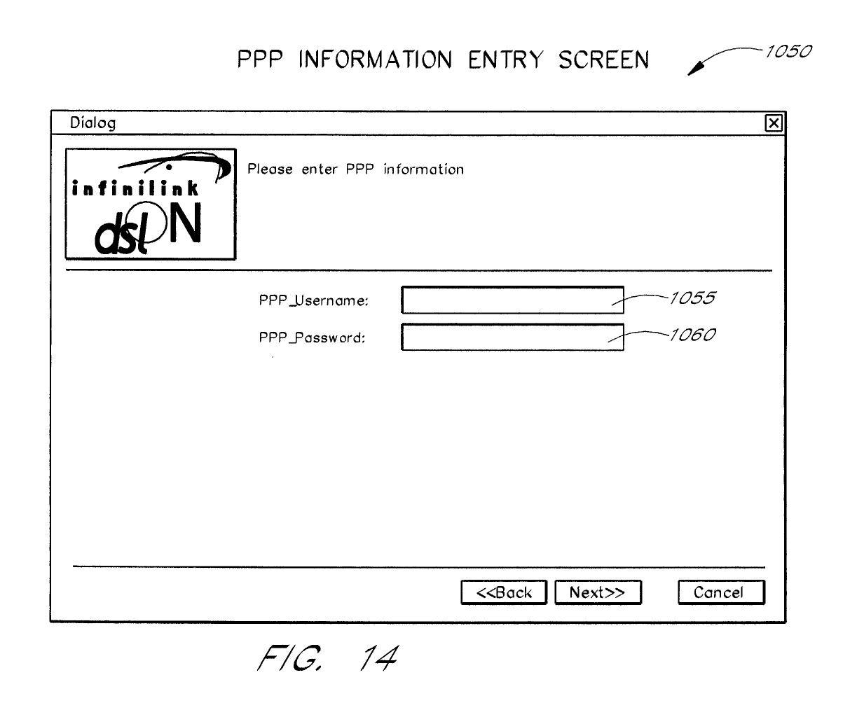

FIG. 13 illustrates a screenshot of the TCP/IP entry screen 1000 according to aspects of one embodiment of the invention. The TCP/IP entry screen 1000 includes an IP address data entry section 1005, a subnet mask data entry section 1010, a default gateway data entry section 1015, a DNS servers data entry section 1020, a host name data entry section 1025, and a domain name data entry section 1030.

Once the TCP/IP entry screen 1000 is displayed, the subscriber 120 may enter the appropriate IP address data for the user system 105 in the IP address data entry section 1005. The subscriber 120 may use the subnet mask data entry section 1010 to enter the appropriate subnet mask information for the user system 105. The subscriber 120 may use the default gateway data entry section 1015 to enter the appropriate default gateway data for the user system 105. The subscriber 120 may use the DNS servers data entry section 1020 to enter the appropriate DNS servers data for the user system 105. The subscriber 120 may use the host name data entry section 1025 to enter the appropriate host name data for the user system 105. The subscriber 120 may use the domain name data entry section 1030 to enter the appropriate domain name data for the user system 105.

Once the appropriate data is entered by the subscriber 120, the subscriber 120 can then select the “next” button to continue with the installation. The subscriber 120 can instead select the “back” button to go to the DSL settings entry screen 950. The subscriber 120 may also select the “cancel” button to terminate the program.

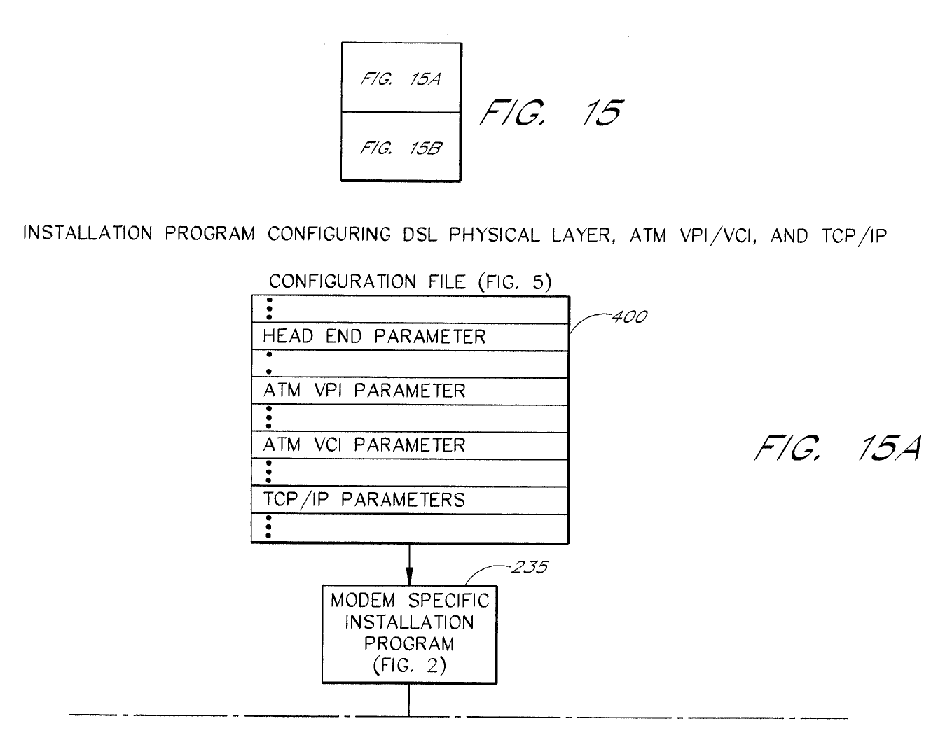

FIG. 14 illustrates a screenshot of the PPP information entry screen 1050 according to aspects of one embodiment of the invention. The PPP information entry screen 1050 includes a PPP username data entry section 1055 and a PPP password data entry section 1060. Once the PPP information entry screen 1050 is displayed, the subscriber 120 may enter the appropriate PPP username data for the user system 105 in the PPP username data entry section 1055. The subscriber 120 may use the PPP password data entry section 1060 to enter the appropriate PPP password information for the user system 105.

Once the appropriate data is entered by the subscriber 120, the subscriber 120 can then select the “next” button to continue with the installation. The subscriber 120 can instead select the “back” button to go to the TCP/IP entry screen 1000. The subscriber 120 may also select the “cancel” button to terminate the program.

Although described above in connection with a DSL modem, one skilled in the art will appreciate that the systems and methods described herein are readily applicable to other broadband telecommunications devices, such as, for example, cable modems, broadband wireless, and the like.

While the above detailed description has shown, described and identified several novel features of the invention as applied to a preferred embodiment, it will be understood that various omissions, substitutions and changes in the form and details of the described embodiments may be made by those skilled in the art without departing from the spirit of the invention. Accordingly, the scope of the invention should not be limited to the foregoing discussion, but should be defined by the appended claims.

What is claimed is:

1. A telecommunications device installation and configuration system for configuring the operation of a DSL telecommunication device and user system, comprising:
a client computer system, comprising:
a DSL telecommunications device;
a storage device for receiving and storing a file of configuration data for the DSL telecommunication device;
a pre-configured telecommunications device; and
a plurality of program files;
a server system comprising:
a telecommunications device that communicates with the pre-configured telecommunication device of the client computer system;
a configuration database system containing configuration data used to control the operation of DSL telecommunication devices;
an identification database system containing data used to identify the client computer system; and
program files that create a configuration file;
a data input interface that receives user identification data from a user of the client computer system;
a display that displays a data entry screen on the client computer system to prompt the user to input the user identification data; and
a controller coupled to the data input interface, to the display, and to the pre-configured telecommunications device, the controller operating to:
send the identification data to the server system via the pre-configured telecommunications device;
receive configuration data from the server system to be transferred to the pre-configured telecommunications device;
generate a communications device control command by converting the configuration data into a configuration file suitable for use with the second telecommunications device; and
use the information in the configuration file to configure the DSL telecommunications device and the client computer system to enable the DSL telecommunications device.

2. A computer hardware installation and configuration system for installing and configuring a computer hardware device, comprising:
a computer system, comprising:
a user interface system; and
a pre-configured telecommunications device;
an identification data structure;
a configuration data structure;
a server system, comprising:
an identification database system;
a configuration data generation system; and
a server communications system;
a computer program operating with the computer system, the computer program operating to:
retrieve user information using the user interface system;
compose the identification data structure;
transmit the identification data structure to the server system using the pre-configured telecommunications device;
retrieve the configuration data structure from the server system using the pre-configured telecommunications device; and
configure the computer hardware device and the computer system to properly operate the computer device;
a server computer program operating with the server system, the server computer program operating to:
retrieve the identification data structure from the computer system using the server communications system;
generate the configuration data structure using data contained in the identification data structure and the configuration data generation system; and
transmit the configuration data structure to the computer system using the server communications system.

3. A computer hardware installation and configuration system of claim 2, wherein the computer hardware device comprises a broadband telecommunications device.

4. A computer hardware installation and configuration system of claim 3, wherein the broadband telecommunications device comprises a digital subscriber line telecommunications device.

5. A computer hardware installation and configuration system for installing and configuring a computer hardware device, comprising:
a computer system, comprising a user interface system;
a configuration data structure; and
a computer program operating with the computer system, the computer program operating to:
retrieve installation and configuration information using the user interface system;
generate the configuration data structure using the installation and configuration information; and
configure the computer hardware device and the computer system using the configuration data structure to properly operate the computer device.

6. A computer hardware installation and configuration system of claim 5, wherein the computer hardware device comprises a broadband telecommunications device.

7. A computer hardware installation and configuration system of claim 6, wherein the broadband telecommunications device comprises a digital subscriber line telecommunications device.

8. A computer hardware installation and configuration system for installing and configuring a computer hardware device, comprising:
a computer system, comprising:
a user interface system; and
a data retrieval device;
an installation and configuration software package residing on a data storage device;
a configuration data structure; and
a computer program operating with the computer system, the computer program operating to:
retrieve user information using the user interface system;
retrieve the installation and configuration software package from the data storage device using the data retrieval device;
generate the configuration data structure using the user information and the installation and configuration software package; and
configure the computer hardware device and the computer system using the configuration data structure to properly operate the computer device.

9. A computer hardware installation and configuration system of claim 8, wherein the computer hardware device comprises a broadband telecommunications device.

10. A computer hardware installation and configuration system of claim 9, wherein the broadband telecommunications device comprises a digital subscriber line telecommunications device.

11. A software data structure for installing and configuring a computer hardware device, comprising data fields containing information pertinent to the installation and configuration of the computer hardware device.

12. A software data structure of claim 11, wherein the computer hardware device comprises a broadband telecommunications device.

13. A software data structure of claim 12, wherein the broadband telecommunications device comprises a digital subscriber line telecommunications device.

14. A software package for installing and configuring a computer hardware device, comprising one or more software programs for installing and configuring various computer hardware devices wherein the software package selects and utilizes an appropriate software program for installing and configuring a particular computer hardware device.

15. A software package of claim 14, wherein the computer hardware device comprises a broadband telecommunications device.

16. A software package of claim 15, wherein the broadband telecommunications device comprises a digital subscriber line telecommunications device.

17. A computer hardware device installation and configuration system for installing and configuring the operation of a computer hardware device on a computer system, comprising:
a computer hardware configuration data structure, comprising:
a data structure independent of the computer hardware device; and
a data content specific for the computer hardware device and the computer system; and
a computer hardware installation and configuration controller, comprising a plurality of computer hardware device specific installation and configuration programs, that operates to:
read the computer hardware configuration data structure;
select an appropriate computer hardware device specific installation and configuration program for the computer hardware device and the computer system; and
utilize the appropriate computer hardware device specific installation and configuration program to install and configure the computer hardware device for proper operation of the computer hardware device on the computer system.

18. A computer hardware device installation and configuration system of claim 17, wherein the computer hardware device comprises a broadband telecommunications device.

19. A computer hardware device installation and configuration system of claim 18, wherein the broadband telecommunications device comprises a digital subscriber line telecommunications device.

20. A computer hardware device installation and configuration system of claim 17, wherein the computer hardware installation and configuration controller receives the computer hardware configuration data structure from a computer network system.

21. A computer hardware device installation and configuration system of claim 17, wherein the computer hardware installation and configuration controller receives the computer hardware configuration data structure from a data storage device.

22. A computer hardware device installation and configuration system of claim 17, wherein the computer hardware installation and configuration controller generates the computer hardware configuration data structure from data received from a user interface system.
